(19) United States
(12) Patent Application Publication
(10) Pub. No.: US 2025/0183976 A1
(43) Pub. Date: Jun. 5, 2025

(54) BEAM PAIR MANAGEMENT IN WIRELESS COMMUNICATION

(71) Applicant: Sony Group Corporation, Tokyo (JP)

(72) Inventors: José FLORDELIS, Lund (SE); Kun ZHAO, Malmö (SE); Fredrik RUSEK, Eslöv (SE)

(21) Appl. No.: 19/044,896

(22) Filed: Feb. 4, 2025

Related U.S. Application Data
(63) Continuation of application No. 17/775,303, filed on May 8, 2022.

(30) Foreign Application Priority Data
Nov. 18, 2019 (SE) 1951328-2

(51) Int. Cl. H04B 7/06; H04W 16/28; H04W 36/08; H04W 52/38; H04W 76/10

(52) U.S. Cl. CPC H04B 7/0695; H04W 16/28; H04W 36/08; H04W 52/38; H04W 76/10

(57) ABSTRACT

Method carried out in a wireless terminal for managing connection to an access network (120), comprising: connecting (501) with the access network using a first transmit spatial filter and a first receive spatial filter; obtaining (50) information associated with a trigger event to switch uplink transmit direction; switching (514), based on said trigger event, from the first transmit spatial filter to a second transmit spatial filter, while maintaining the first receive spatial filter.

### CROSS REFERENCE TO RELATED APPLICATIONS

This application is a continuation of U.S. patent application Ser. No. 17/775,303, filed May 8, 2022, which is a National Stage Application under 35 U.S.C. 371 and claims the benefit of PCT Application No. PCT/EP2020/082161 having an International Filing Date of Nov. 13, 2020, which designated the United States, which PCT application claimed the benefit of Swedish Patent Application No. 1951328-2, filed Nov. 18, 2019.

### TECHNICAL FIELD

Solutions provided herein are associated with configuration and management of transmit direction used for uplink and downlink communication between a wireless terminal and an access node of a wireless network.

### BACKGROUND

Radio communication systems operating under various iterations of the 3^{rd} Generation Partnership Project (3GPP) offer high peak data rates, low latency, improved system capacity, and low operating cost resulting from simple network architecture. These include inter alia Long-Term Evolution (LTE) system and more recently so called 5G networks and New Radio (NR). Orthogonal frequency division multiplexing (OFDM) radio technology has been incorporated to enable high data bandwidth to be transmitted efficiently while still providing a high degree of resilience to reflections and interference. In such radio communication systems, the transmit power of each wireless terminal, also referred to as User Equipment (UE), needs to be 20 maintained at a certain level and regulated by the network. A base station, or access node, of a 5G wireless network is referred to as a gNB.

When operating a UE in the mm Wave frequencies, such as in NR, the functionality of beamforming is essential, since it—contrary to an omnidirectional transmission—allows transmissions to be directed so that the signal to noise ratio is improved. However, there are restrictions to handle maximum exposure of signal energy to a user utilizing the UE. Hence, it has been concluded in 3GPP that the UE in FR2 (Frequency Range 2—a spectrum at least partly within the mm wave range) will likely face critical restriction on the Maximum Permitted Exposure (MPE) due to the governments and regulators' limitations. Two methods have therefore been introduced during Rel-15 in the specifications to enable the UE to comply with regulatory exposure limits. One is Power Management Maximum Power Reduction (P-MPR), and the other is maxUplinkDutyCycle capability.

To ensure that a UE can always meet the MPE requirement, the P-MPR power reduction mechanism allows a UE to autonomously reduce its UL transmit power without any limitations. However, an unintended effect of this mechanism is that radio link failures and connection releases might occur due to significant and unpredictable application of P-MPR by the UE. The radio link failure problem has been recognized as an important one and is actively being discussed in 3GPP RAN4, a Technical Specifications Group associated with radio performance and protocol aspects in Radio Access Networks. Various solutions to this problem have been suggested, including the implementation of the maxUplinkDutyCycle.

The UE can signal to the gNB maxUplinkDutyCycle-FR2 as a static capability, indicating its preferred uplink duty cycle, such as one of 15%, 20%, 25%, 30%, 40%, 50%, 60%, 70%, 80%, 90%, 100%. The preferred uplink duty cycle may be dependent on inter alia the character of the antenna of the UE and may e.g. be determined based on compliance testing of the UE model.

In operation, if the UE has signaled a static capability maxUplinkDutyCycle-FR2, and the percentage of uplink resources allocated to the UE by the gNB does not exceed maxUplinkDutyCycle-FR2, then it is understood that the UE can follow the UL scheduling without applying P-MPR. On the other hand, if the percentage of uplink resources allocated to the UE by the gNB exceeds maxUplinkDutyCycle-FR2, then the UE follows the UL scheduling and applies P-MPR as needed. It is important to note that even though a maxUplinkDutyCycle-FR2 capability is signaled by the UE, the gNB may disregard it. Hence, the UE might still need to apply P-MPR.

It follows that alternative methods to deal with radio link failures and connection releases are needed.

### SUMMARY

Solutions are provided herein which target the identified need. These solutions are provided in the independent claims, and various embodiments are set out in the dependent claims.

According to a first aspect, the proposed solutions are related to a method carried out in a wireless terminal adapted to configure uplink output power of radio transmission. The method comprises
connecting with the access network using a first transmit spatial filter and a first receive spatial filter;
obtaining information associated with a trigger event to switch uplink transmit direction;
switching, based on said trigger event, from the first transmit spatial filter to a second transmit spatial filter, while maintaining the first receive spatial filter.

According to a second aspect, the proposed solutions are related to a method carried out in an access network for managing connection with a wireless terminal. The method comprises
connecting with the wireless terminal using a first transmit spatial filter and a first receive spatial filter;
obtaining information associated with a trigger event to switch uplink transmit direction from the wireless terminal;
configuring a second receive spatial filter based on said trigger event;
switching, based on said trigger event, from the first receive spatial filter to the second receive spatial filter, while maintaining the first transmit spatial filter.

By means of the proposed solutions, the probability of radio link failure or connection release, e.g. due to the application of P-MPR by the UE to UL transmissions, is reduced without degrading the performance of DL transmission from the network to the terminal.

### BRIEF DESCRIPTION OF THE DRAWINGS

FIG. 1A schematically illustrates a radio communication network and communication between an access node and a wireless terminal.

FIG. 1B schematically illustrates a radio communication network and communication between an access node and a wireless terminal according to various embodiments, in which uplink and downlink is separated.

FIG. 1C schematically illustrates an alternative to the embodiment of FIG. 1B.

FIG. 2 schematically illustrates a radio communication terminal configured to operate according to various embodiments.

FIG. 3 schematically illustrates an access node configured to operate according to various embodiments.

FIGS. 4 schematically illustrates a network node configured to operate according to various embodiments.

FIGS. 5A-5C schematically illustrate signaling diagrams between different entities of a system according to various embodiments, for setting up separated uplink and downlink connections.

FIG. 6 schematically illustrates a signaling diagram between different entities of a system according to various embodiments, for terminating separation of uplink and downlink connections.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various propositions exist on how to manage moderation of terminal output power. This has become even more relevant as wireless communication enters mm wave frequency ranges, e.g. FR2 including a Frequency Range of 24250-52600 MHZ, at which spatial filters and antennas may be employed for transmission in finer cone angles. To meet MPE requirements, both P-MPR and maxUplinkDutyCycle may be employed.

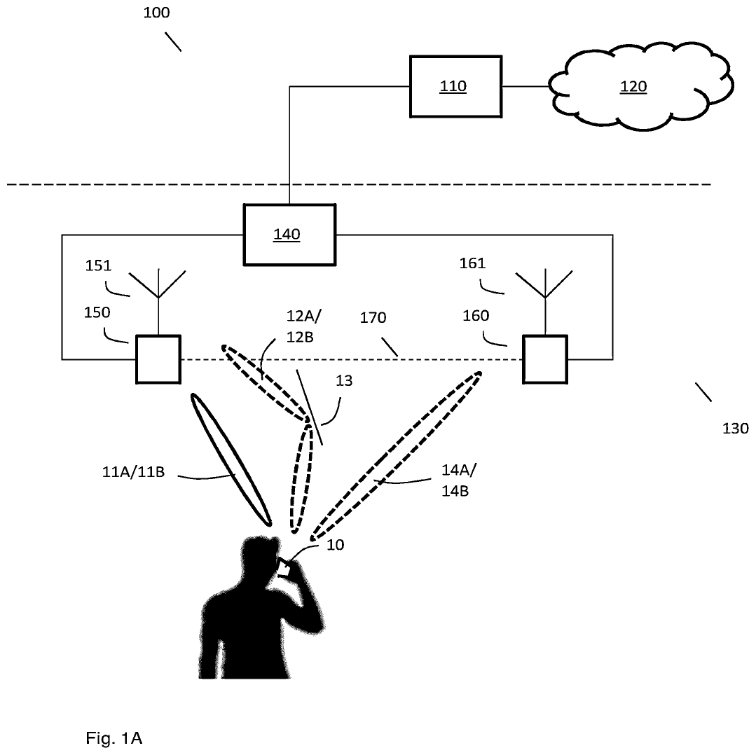

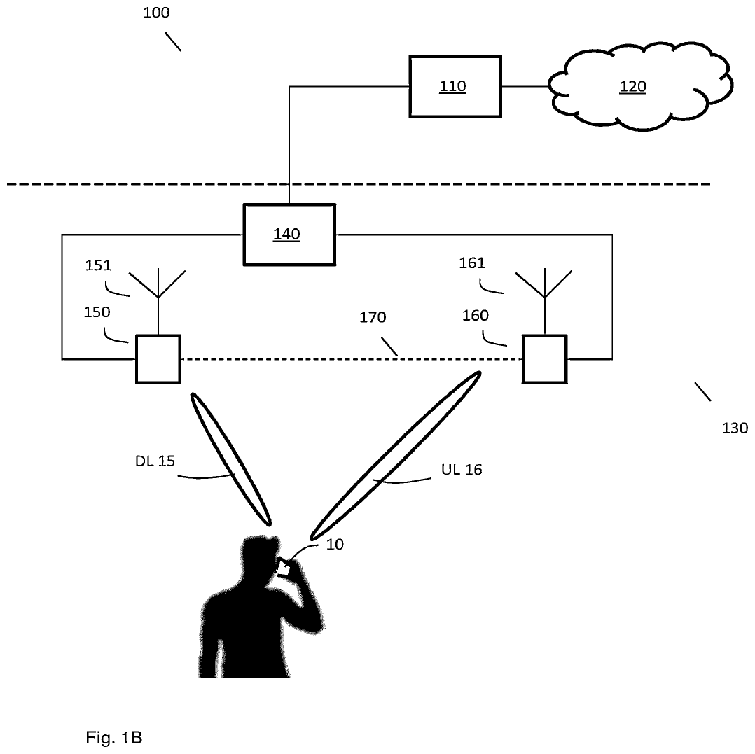

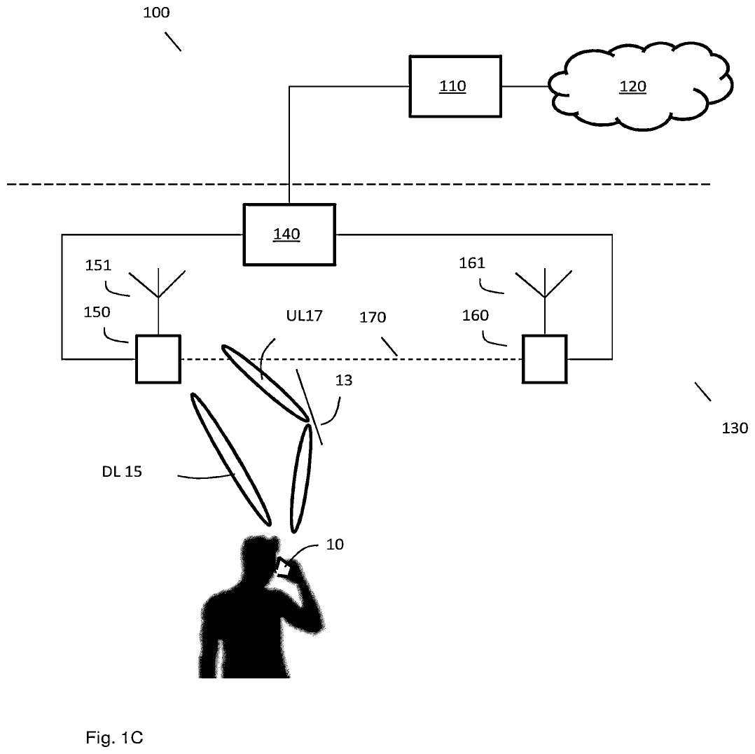

FIG. 1A schematically illustrates a wireless communication system including a wireless network 100, and a terminal (or UE) 10 configured to wirelessly communicate with the wireless network 100. The wireless network may be a radio communication network operating under general and specific regulations and limits published by the 3GPP, such as a New Radio (NR) network which may operate under FR 2. The wireless network 100 may include a core network 110, which is connected to other networks 120, such as the Internet. The wireless network 100 further includes an access network 130, which comprises a plurality of access nodes 150, 160. An access node is an entity executing the wireless connection with wireless terminals 10. As such, each access node 150, 160 comprises or is connected to a transmission point TRP 151, 161, including an antenna arrangement for transmitting and receiving radio signals. The access node(s) 150, 160 may be a gBN and be configured for beamforming as introduced for 5G. The access node 150, 160 may also be referred to as a base station. The drawing further illustrates a network node 140, which may incorporate a function for managing communication with and cooperation of the access nodes 150, 160, such as a user plane function. In various embodiments, a logical communication interface 170 may be provided between the access nodes 150, 160.

The wireless terminal 10 may be any device operable to wirelessly communicate with the network 100 through the radio access node 150, such as a mobile telephone, computer, tablet, a M2M device or other. In various embodiments, the terminal 10 may be configured to communicate in more than one beam, which are preferably orthogonal in terms of coding and/or frequency division and/or time division. Configuration of beams in the terminal 10 may be realized by using an antenna array configured to provide an anisotropic sensitivity profile to transmit radio signals in a particular transmit direction.

FIG. 1A illustrates a scenario in which a user operates the UE 10 in connected mode, by communication via the first TRP 151 of the first access node 150. As such, the UE uses a first UE transmit spatial filter for an uplink (UL) channel 11A and a first UE receive spatial filter for a downlink (DL) channel 11B, configured by the first access node 150 in RRC signaling. Normally, the TRP 151 operates with beam correspondence, employing a first TRP transmit spatial filter for the DL (Tx) channel 11B and a first TRP receive spatial filter for the UL (Rx) channel 11A. In broad terms, beam correspondence applies when a DL transmission, via one or more beams, from a transmitting wireless node may be used to identify a corresponding DL reception beam for a receiving wireless node. At the TRP 151, Tx/Rx beam correspondence may apply e.g. if the TRP 151 is able to determine a TRP Rx beam for UL reception based on the UE's 10 DL measurement on one or more Tx beams from the TRP 151, or if the TRP 151 is able to determine a TRP Tx beam for the DL transmission based on TRP 151 UL measurement on one or more Rx beams of the TRP 151. Moreover, Tx/Rx beam correspondence at the UE 10 holds if at least one of the following is satisfied: the UE 10 is able to determine a UE Tx beam for the uplink transmission based on UE's downlink measurement on UE's 10 one or more Rx beams; UE 10 is able to determine a UE Rx beam for the downlink reception based on TRP's 151 indication based on uplink measurement on UE's 10 one or more Tx beams; or capability indication of UE beam correspondence related information to TRP is supported.

During operation of the terminal 10, proximity of the user may be detected. Based on this proximity, and regulated levels for transmit power, the terminal 10 may be configured to employ a power reduction, such as provided under the 3GPP as the described P-MPR.

As alternatives to actually applying a power reduction under P-MPR, and thereby risking radio link failures and connection releases, different methods are illustrated in FIG. 1A. One example is to switch to a different beam pair 12A/12B, wherein both transmit and receive spatial filters are changed in both the terminal and in the TRP. The UL part 12A of this beam pair may e.g. be transmitted in a direction away from the user, such that no P-MPR is required. This beam pair 12A/12B may e.g. be reflected by an element or panel 13, in propagation between the terminal 10 and the TRP 151. However, it cannot be guaranteed that such a different beam pair can be found. Another example may be handing over the terminal 10 to a different access node 160, by setting up a new beam pair 14A/14B, again where both transmit and receive spatial filters are changed in the terminal, and a new spatial filter configuration is set up in the TRP 161 of that access node 160.

The main idea behind these alternative methods is to find an UL/DL beam-pair which does not suffer from the MPE issue. However, there are other problems with these methods. Regarding the switch to a different beam pair 12A/12B of the same access node 150 using the same TRP 151, it should be noticed that is not always possible to find an alternative UL/DL beam-pair between the terminal 10 and the TRP 151. This is particularly applicable to FR2, due to the specular nature of the propagation channel at mm wave frequencies. Regarding the second method, it is important to realize that a handover based on MPE considerations rather than received signal strength may lead to a weaker radio link. For example, in the situation depicted in FIG. 1A, the UE is handed over from the first access node 150 to the second access node 160, thereby avoiding the MPE issue. However, although the terminal 10 is now able to transmit in the UL without applying P-MPR, the DL between gNB2 and the terminal 10 may be afflicted by higher pathlosses compared to the first access node 150. In other words, this method avoids radio link failure in the UL possibly at the expense of a reduced received signal strength in the DL.

FIG. 1B illustrates an example of an embodiment according to a proposed further solution, devised to avoid radio link failure due to P-MPR which, at the same time, allows the terminal 10 to connect to the access node with the strongest DL.

The terminal 10 in the figure is connected to the first TRP 151 of access node 150. Due to the proximity of the user, the terminal 10 needs to apply P-MPR, which significantly reduces the amount of power allowable for UL transmissions to the first TRP 151. However, the link between the terminal 10 and the TRP 161 of the second access node 160 does not suffer from the MPE issue, and UL transmissions are possible at full power. On the other hand, the strength of the radio link between the terminal 10 and the first access node 150 (e.g. as measured in terms of DL reference-signal received power, RSRP) is larger than that between the terminal 10 and the second access node 160. In fact, the situation depicted is such that:
Best UL data-rates and least probability of UL radio link failure are obtained when the terminal 10 transmits to the TRP 161 of the second access node 160.
Best DL data-rates and least probability of DL radio link failure are obtained when the terminal 10 receives from the first TRP 151 of access node 150.

In the light of this asymmetric situation, created by the necessity of applying P-MPR reductions in the UL due to MPE considerations, a solution is hereby proposed in which the UL beam-pair and the DL beam-pair are established to different TRPs 151, 161, associated with access nodes 150, 160, such as different gNBs. This is obtained, in the terminal 10, by switching from using a first transmit spatial filter to a second transmit spatial filter, while maintaining a first receive spatial filter. This constitutes a departure from the state of the art, which currently assumes that the DL beam and the UL beam are established to the same gNB. Since UL transmissions contain information that is relevant to the DL, and vice versa, the access nodes involved (e.g., the first access node 150 and the second access node 160 in the figure) are interconnected and can exchange information in a timely manner. This may in some embodiments be managed via a network node 140. In other embodiments, the interface 170 between the access nodes, such as an Xₙ interface in a 5G implementation, may be used for communication between the access nodes 150, 160. In yet another embodiment, the first TRP 151 and the second TRP 161 may be controlled by common access node logic. Description of examples for the proposed method will be outlined further below with reference to signal diagrams.

FIG. 1C schematically illustrates an alternative to the embodiment of FIG. 1B. In this embodiment, the connection is maintained with the same TRP 151, but by switching from a first transmit spatial filter to a second transmit spatial filter, while maintaining the first receive spatial filter, only the uplink transmit direction is changed. This embodiment relies on the presence of more than one beam direction being available for transmitting from the terminal 10 to reach the TRP 151.

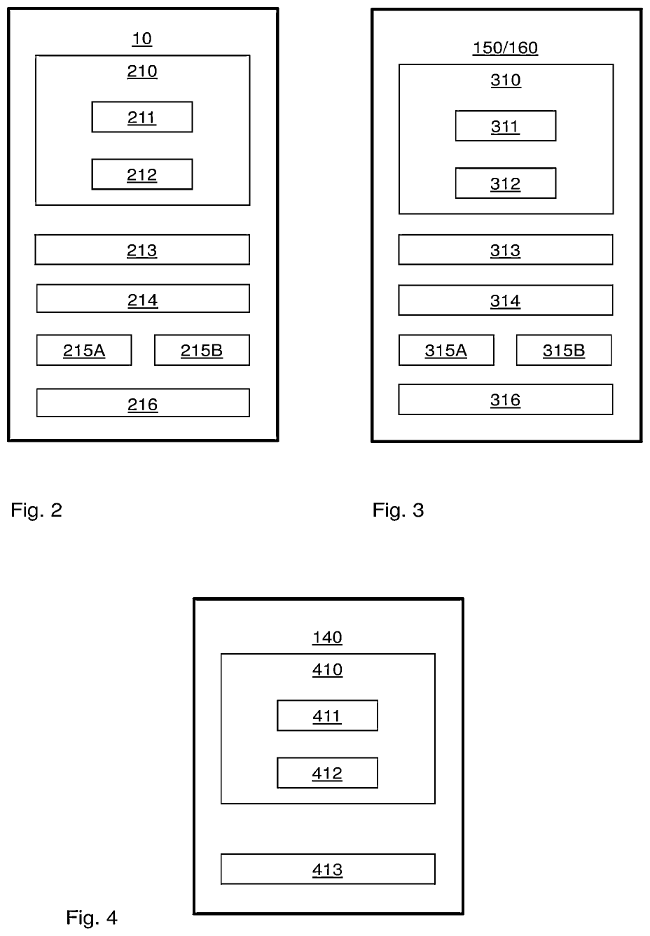

FIG. 2 schematically illustrates an embodiment of the wireless terminal 10 for use in a wireless network 100 as presented herein, and for carrying out the method steps as outlined.

The terminal 10 may comprise a radio transceiver 213 for communicating with other entities of the radio communication network 100, such as the access node 150. The transceiver 213 may thus include a radio receiver and transmitter for communicating through at least an air interface.

The terminal 10 further comprises logic 210 configured to communicate data, via the radio transceiver, on a radio channel, to the wireless communication network 100 and/or directly with another terminal, by Device-to Device (D2D) communication.

The logic 210 may include a processing device 211, including one or multiple processors, microprocessors, data processors, co-processors, and/or some other type of component that interprets and/or executes instructions and/or data. Processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage mediums. For example, memory storage 212 may include a random access memory (RAM), a dynamic random access memory (DRAM), a cache, a read only memory (ROM), a programmable read only memory (PROM), flash memory, and/or some other type of memory. Memory storage 212 may include a hard disk (e.g., a magnetic disk, an optical disk, a magneto-optic disk, a solid state disk, etc.).

The memory storage 212 is configured for holding computer program code, which may be executed by the processing device 211, wherein the logic 210 is configured to control the terminal 10 to carry out any of the method steps as provided herein. Software defined by said computer program code may include an application or a program that provides a function and/or a process. The software may include device firmware, an operating system (OS), or a variety of applications that may execute in the logic 210.

The terminal 10 may further comprise an antenna 214, which may include an antenna array. The logic 210 may further be configured to control the radio transceiver to employ an anisotropic sensitivity profile of the antenna array to transmit radio signals in a particular transmit direction. In various embodiments, this may involve applying a transmit spatial filter 215A for adapting inter alia the spatial sensitivity of the antenna 214 in UL transmission, and a receive spatial filter 215B for adapting inter alia the spatial sensitivity of the antenna 214 in DL reception.

The terminal 10 may further comprise one or more sensors 216, such as a proximity sensor, accelerometer, magnetometer, etc., configured to sense and detect orientation or proximity to another object, such as a user of the terminal 10.

Obviously, the terminal may include other features and elements than those shown in the drawing or described herein, such as a power supply, a casing, a user interface etc.

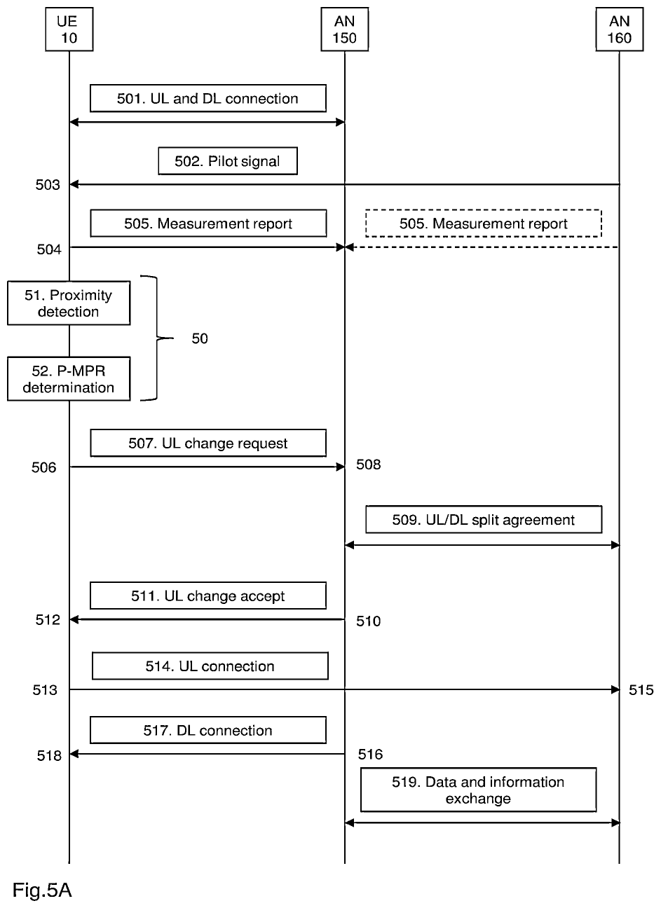

FIG. 3 schematically illustrates an access node 150 for use in a radio communication network 100 as presented herein, and for carrying out the method steps as outlined for controlling link configuration for a terminal 10. It shall be noted that the embodiment of FIG. 3 may equally well be used for the second access node 160.

The access node 150 includes or operates as a base station of a radio communication network 100, such as a gNB, configured for operation in a mm wave frequency band. The access node 150 may comprise a radio transceiver 313 for wireless communicating with other entities of the radio communication network 100, such as the terminal 10. The transceiver 313 may thus include a radio receiver and transmitter for communicating through at least an air interface.

The access node 150 further comprises logic 310 configured to communicate data, via the radio transceiver, on a radio channel, with terminal 10. The logic 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 150 to carry out any of the method steps as provided herein. Software defined by said computer program code may include an application or a program that provides a function and/or a process. The software may include device firmware, an operating system (OS), or a variety of applications that may execute in the logic 310.

The access node 150 may further comprise or be connected to an antenna 314, connected to the radio transceiver 313, which antenna may include an antenna array. The logic 310 may further be configured to control the radio transceiver to employ an anisotropic sensitivity profile of the antenna array to transmit and/or receive radio signals in a particular transmit direction. In various embodiments, this may involve applying a transmit spatial filter 315A for adapting inter alia the spatial sensitivity of the antenna 314 in DL transmission, and a receive spatial filter 315B for adapting inter alia the spatial sensitivity of the antenna 314 in UL reception. The access node 150, or alternatively only the antenna 314, may form a transmission point TRP for the access node 150.

The access node 150 may further comprise a communication interface 316, operable for the access node 150 to communicate with other nodes of the wireless network 100, such as a higher network node 140 or with another access node 160.

In various embodiment, the access node 150 is configured to carry out the method steps described for execution in an access node, or for controlling a TRP, as outlined herein.

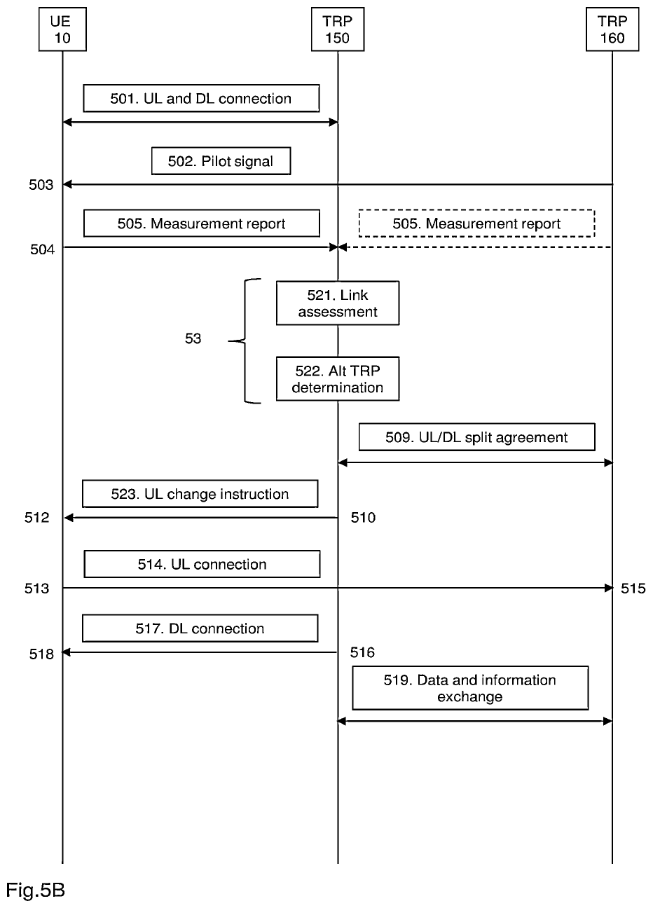

FIG. 4 schematically illustrates a network node 140 for use in a radio communication network 100 as presented herein, and for carrying out the method steps as outlined for controlling link configuration for a terminal 10 in various embodiments. Herein, the network node 140 represents a node other than the access nodes, e.g. a node realizing a user plane function.

The network node 140 comprises logic 410 configured to communicate data with other nodes of the network 100, via an interface 413. The logic 410 may include a processing device 411, including one or multiple processors, microprocessors, data processors, co-processors, and/or some other type of component that interprets and/or executes instructions and/or data. Processing device 411 may be implemented as hardware (e.g., a microprocessor, etc.) or a combination of hardware and software (e.g., a system-on-chip (SoC), an application-specific integrated circuit (ASIC), etc.). The processing device 411 may be configured to perform one or multiple operations based on an operating system and/or various applications or programs.

The logic 410 may further include memory storage 412, which may include one or multiple memories and/or one or multiple other types of storage mediums. For example, memory storage 412 may include a random access memory (RAM), a dynamic random access memory (DRAM), a cache, a read only memory (ROM), a programmable read only memory (PROM), flash memory, and/or some other type of memory. Memory storage 412 may include a hard disk (e.g., a magnetic disk, an optical disk, a magneto-optic disk, a solid state disk, etc.).

The memory storage 412 is configured for holding computer program code, which may be executed by the processing device 411, wherein the logic 410 is configured to control the network node 140 to carry out any of the method steps as provided herein. Software defined by said computer program code may include an application or a program that provides a function and/or a process. The software may include device firmware, an operating system (OS), or a variety of applications that may execute in the logic 410.

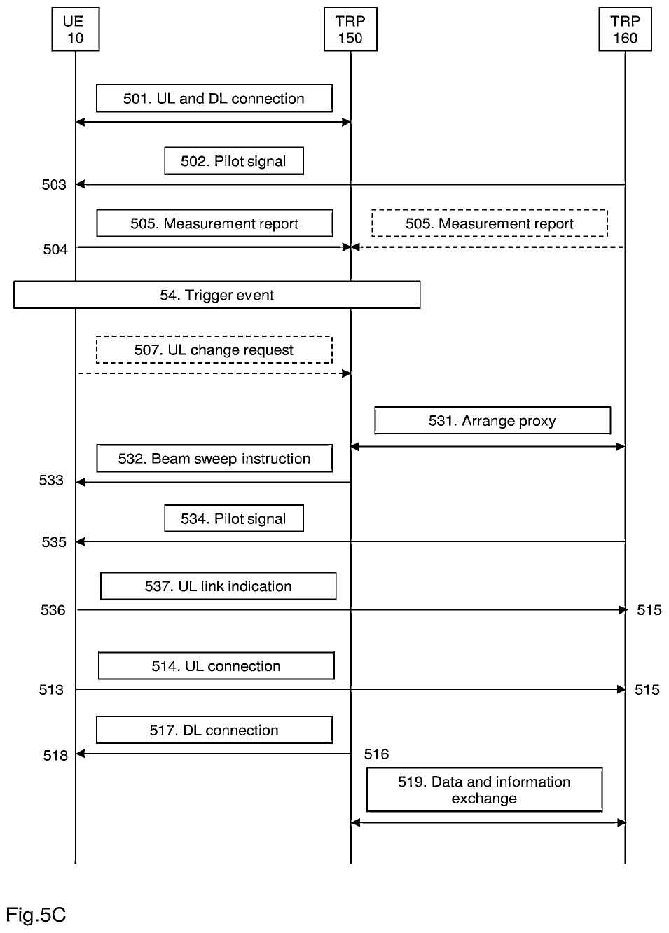

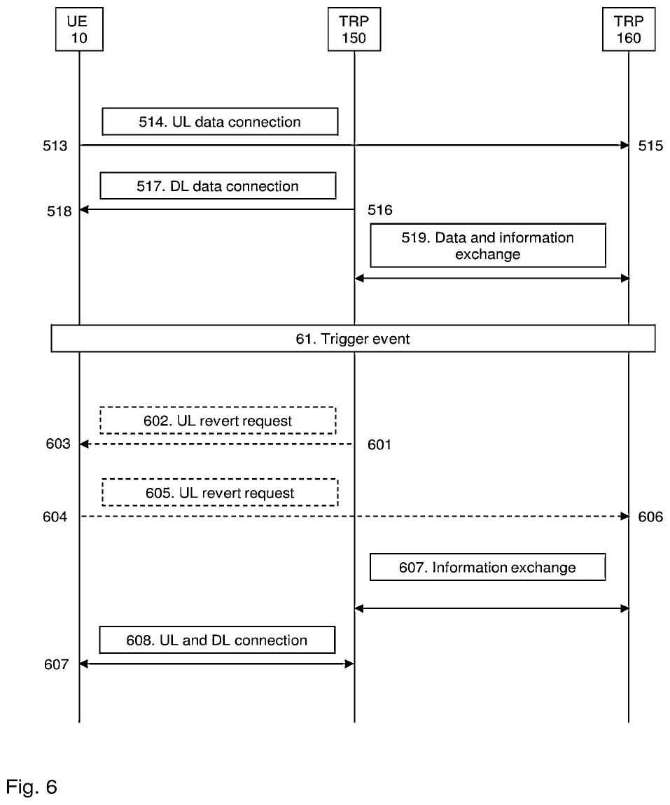

Example embodiments of methods according to the proposed solution will now be provided, with reference to FIGS. 5A-5C, and FIG. 6. On a general note, splitting of the DL/UL beam-pairs into an UL beam-pair to the serving access node 150 and a DL beam-pair to a secondary access node 160, or vice versa, can be initiated by the terminal 10, or by the serving access node 150. The splitting of the DL/UL beam-pairs can be temporary, or permanent during the time the terminal 10 is in connected state. If the duration of the DL/UL beam-pair split is temporary, the terminal 10 may, at the end of the split period, fall back to the serving access node 150, or the secondary access node 160 may become the serving access node.

FIG. 5A schematically illustrates a signaling diagram covering various embodiments, outlining events carried out in and between a terminal 10, a first access node 150 having an associated first TRP 151, and a second access node 160 having an associated second TRP 161.

In step 501, the terminal 10 is connected to the wireless network through the first access node 150, in both UL and DL. From the terminal 10 perspective, this involves connecting with the access network 130 using a first transmit spatial filter 215A and a first receive spatial filter 215B. From the access network 130 perspective, this involves connecting with the wireless terminal 10 using a first transmit spatial filter 315A and a first receive spatial filter 315B. In the shown example, this is obtained using the first access node 150 operating the first TRP 151.

Meanwhile, the terminal 10 regularly performs measurements of pilot signals 502 from other cells, i.e. transmitted from other TRPs under control of access nodes. This includes receiving 503 a pilot signal, such as a Synchronization Signal Block SSB, transmitted from TRP 161 by access node 160.

Regularly, the terminal 10 also provides 504 measurement reports 505 to the access node 150 with which it's connected.

At a certain instant, the terminal 10 obtains information associated with a trigger event 50 to switch uplink transmit direction. In the embodiment of FIG. 5A, this may include or be based on detection 51 of close proximity of an object, which may be the body of the user of the terminal 10. This detection may be determined by the proximity sensor 216. Moreover, the trigger event 50 may include determination 52 by terminal 10 of a required transmit power reduction, such as P-MPR, that must be applied by the terminal 10 for transmitting in the direction obtained by using the first transmit spatial filter, in order to comply with a criterium such as an exposure level or a maximum transmit power level.

In response to the said trigger event 50, the terminal 10 may switch from using the first transmit spatial filter to a second transmit spatial filter, while maintaining the first receive spatial filter. Thereby, the problem caused by the transmit direction is overcome by suitably changing the transmit direction from the terminal, e.g. so as to avoid or minimize the requirement to apply P-MPR. Meanwhile, the DL receive filter and the associated connection 15 is maintained, which may be the most appropriate link to the access network 120. In this context, switching spatial filter may include changing parameters or couplings of the transmit spatial filter 215A.

The change of transmit direction by switching transmit spatial filter 215A for controlling the spatial sensitivity properties of the antenna 214, may involve the terminal transmitting 506, to the access network 120 (and typically the first access node 150), information identifying a request 507 to change TRP beam. The transmitted request 507 may identify, to the access network 120, that the trigger is potential violation of an exposure limit, or a level of required power reduction. This way, the access node 120 may treat the request with an appropriate priority, e.g. with respect to other traffic handled in the cell of the present access node 150. For instance, a first priority in handling a change of UL path for the terminal 10 may be set by the access network 120 if the request 507 identifies that the required terminal power reduction is below a certain level, or by determining that the terminal 10 would not lose UL connection if the present UL transmission direction, and associated transmit spatial filter 215A, is maintained. On the other hand, a second priority which is higher than the first priority may be applied by the access network 120 to accept and arrange for a change of UL transmit direction if the request 507 identifies that the required terminal power reduction exceeds a certain level, or by determining that the terminal 10 would lose UL connection if the present UL transmission direction is maintained.

In some embodiments the information identifying the request 507 to change TRP beam identifies beam information associated with the first transmit spatial filter. This may involve identification of the TRP beam, or a metric associated with the beam.

In some embodiments the information identifying a request 507 to change TRP beam identifies beam information associated with the second transmit spatial filter. This beam information may include beam identity of one or more TRP beams as detected by the terminal 10 from e.g. pilot signals transmitted by the first 151 and or second 161 TRP, and indication of acquired measurements of received signal strength from such beam or beams.

In response to the request 507, the terminal 10 may receive 512 information identifying acceptance 511, from the access network 120 (typically from the first access node 150), to transmit with the second transmit spatial filter. Thereby, the terminal may be configured to change transmit direction, while maintaining the first receive spatial filter. This may include receiving, from the access network 120, beam information identifying the second transmit spatial filter. Thereby, by using the second transmit spatial filter, a switched UL connection 514 may be set to the access network 120. As indicated in the embodiment of FIG. 5A, the received beam information may configure the terminal to set up the UL connection 514 with the second TRP 161.

During operation of this beam-split scenario, UL connection is provided to the second access node 160, through its TRP 161, while the DL connection is provided from the first access node 150 through its TRP 151. In this scenario, data and control information 519 is synchronized by the access network 120. In an embodiment, there is no distinction made between user plane and data plane, or between PDSCH and PDCCH connection. All UL transmission from the terminal 10, including ACK/NACK communication with respect to DL signaling, is configured using the changed second transmit spatial filter, while all DL reception is configured using the first receive spatial filter, including ACK/NACK communication with respect to UL signaling.

Synchronization may include one of the first 150 and second 160 access node collecting information from and/or providing information to the other. In one embodiment, the first, original, access node 150 maintains overall control, and connects to the second access node 160 to obtain data and control information originating from the terminal 10 from the second access node 160. In another embodiment, overall control of the connection may be transferred from the first access node 150 to the second access node 160, when the second access node is used for receipt of UL transmission from the terminal. Communication of data and control information 519 may be carried out over an intra-access node interface 170, or alternatively though the network node 140.

FIG. 5B is similar to the embodiment of FIG. 5A, but illustrates an embodiment in which the trigger event 53 is detected in the access network 120, wherein information 523 associated with the trigger event to switch uplink transmit direction is conveyed 510 to the terminal 10, where the information is obtained 512. In the shown embodiment, the trigger event may include the connected first access node 150 making a link assessment 521 of the connection to the terminal 10, e.g. a measurement of received signal strength from the terminal 10. Based thereon, the access node 120 may determine 522 an alternative UL receive beam for the terminal 10 to use. This may be based on signal strength measurements 505 obtained from the terminal 10. This may identify an alternative beam of the first access node 150 through its TRP 151 as in FIG. 1C. In another embodiment, this determination 522 may identify a beam of the second access node 160 through its TRP 161, as in FIG. 1B and FIG. 5B. The first 150 and second 160 access node may thus communicate 509 to obtain an UL/DL split agreement. This communication 509 may be carried out over an intra-access node interface 170, or alternatively though the network node 140.

Where an agreement is made for an UL/DL split in the access network 120, information 523 associated with the trigger event to switch uplink transmit direction is conveyed 510 to the terminal 10 in the form of an UL change instruction. This information 523 may include beam information for the new UL beam to use, thereby identifying the second transmit spatial filter to employ in the terminal 10.

FIG. 5C illustrates another embodiment, in which a trigger event 54 to switch uplink transmit direction occurs. This may e.g. be one of the examples 50 outlined with reference to FIG. 5A, thus including an UL change request 507, or examples 53 as outlined with reference to FIG. 5B. In this embodiment, a switch of transmit spatial filter in the terminal 10 is executed in a transparent or semi-transparent way, such that the terminal is not aware that UL transmission and DL reception are in reality handled by two different access nodes 150, 160. The serving access node 150 may break beam correspondence by requesting an UL beam sweep from the terminal 10. A configuration is made in the access network 120 such that the second access node 160 is arranged 531 to act as a proxy panel of the first access node 150. By means of this configuration, the second access node 160 is controlled to handle, either autonomously or in coordination with the first access node 150, the UL beam sweep procedure with the terminal 10.

The terminal 10 thus receives 533 information 532 from the serving access node of the access network 120, which information identifies a request for the terminal to carry out a beam sweep. The terminal 10 thereby executes a beam sweep, in which a pilot signal 534 is detected 535, originating from the second access node 160. However, since the second access node 160 is configured 531 to act as a proxy panel for the first access node 150, the terminal 10 will understand the pilot signal 534 as being received from the serving first access node 150. The terminal 10 may thus reply with a link indication 537, indicating a beam of the received pilot signal 534, whereby the terminal 10 may be configured to apply a transmit spatial filter based on said beam sweep to set up an UL connection 514 with the second access node 160. Meanwhile, the DL connection 517 with the first access node 150 may be maintained. In an alternative embodiment, the beam sweep instruction 532 can instruct an UL beam sweep. In such a case, pilots 534 go from UE 10 to TRP 160, and “UL link indication” 537 goes from TRP 160 to UE 10.

FIG. 6 schematically illustrates operation after the setup of an UL and DL connection to different TRPS 151, 161, operated by different access nodes 150, 160. At a certain point, a trigger event 61 may occur to revert back and combine UL and DL connection with a common access node 150, 160. In some embodiments, splitting of the DL/UL beam-pairs can be temporary, wherein the trigger event 61 may be a timer. In other embodiment, the splitting may be permanent during the time the terminal 10 is in connected state. In some embodiments the trigger 61 may be that the cause of the beam split, such as an UL transmit direction being subjected to P-MPR, is no longer applicable for UL communication with the first TRP 151.

In some embodiments, the terminal 10 may be configured to transmit 604, to the second access node 160 or at least through the second TRP 161, information identifying a request 605 to revert back to the first TRP, or to revert from a DL/UL beam-pair split state. In other embodiments, the information identifying a request 602 to revert back to the first TRP, or to revert from a DL/UL beam-pair split state, may originate from the access network 120 and be sent 601 in DL from the first TRP 151 to the terminal 10. If the request 602, 605 is successful, the access network 120 may configure either the first TRP 151 and its serving access node 150, or the second TRP 161 and its serving access node 160, to serve both UL transmissions and DL transmission. Connection to the other access node can thus be discontinued. This may involve the terminal 10 receiving 607, from the first TRP, information identifying acceptance to use a transmit spatial filter for uplink to the first TRP. By terminating the UL/DL beam split, unnecessary overhead caused by the required synchronization of the access nodes 150, 160 operating the two TRPs 151, 161, respectively, may be minimized.

In various embodiments, communication between the terminal 10 and the access network 120 is carried out in a mm wave frequency band, such as in FR2 of a 5G system. Various solutions have been outlined which target the object of reducing the probability of radio link failure or connection release, e.g. due to the application of P-MPR by the terminal to UL transmissions, without degrading the performance of DL transmission from the network to the terminal. The scope is defined by the terms of the claims. Furthermore, various embodiments of the proposed solutions may include any combination of the following clauses C:

C1. Method carried out in a wireless terminal for managing connection to an access network, comprising:
connecting with the access network using a first transmit spatial filter and a first receive spatial filter;
obtaining information associated with a trigger event to switch uplink transmit direction;
switching, based on said trigger event, from the first transmit spatial filter to a second transmit spatial filter, while maintaining the first receive spatial filter.
C2. The method of C1,
wherein the first transmit spatial filter and the first receive spatial filter are configured for communication in a first direction with a first transmission point, TRP, of the access network, and
wherein the second transmit spatial filter is configured for uplink communication with a second TRP of the access network in a second direction, which is different from the first direction.

C3. The method of C1 or C2, wherein said information identifies a required transmit power reduction (P-MPR) by the wireless terminal for using the first transmit spatial filter.

C4. The method of any preceding clause, wherein obtaining information includes
transmitting, to the access network, information identifying a request to change TRP beam, and
receiving, based on the request to change TRP beam, information identifying acceptance to transmit with the second transmit spatial filter.

C5. The method of C4, wherein said information identifying a request to change TRP beam identifies beam information associated with the first transmit spatial filter.

C6. The method of C4 or C5, wherein said information identifying a request to change TRP beam identifies beam information associated with the second transmit spatial filter.

C7. The method of any preceding clause, wherein obtaining information includes receiving, from the access network, beam information identifying the second transmit spatial filter.

C8. The method of any of C1-C3, wherein obtaining information includes
receiving, from the access network, information identifying a request for the terminal to carry out a beam sweep;
identifying the second transmit spatial filter based on said beam sweep.

C9. The method of C2, comprising
transmitting, to the access network, information identifying a request to revert back to the first TRP, and
receiving, from the access network, information identifying acceptance to use a transmit spatial filter for uplink to the first TRP.

C10. The method of any preceding clause, wherein communication with the access network is carried out in a mm wave frequency band.

C11. Method, carried out in an access network for managing connection with a wireless terminal, comprising:
connecting with the wireless terminal using a first transmit spatial filter and a first receive spatial filter;
obtaining information associated with a trigger event to switch uplink transmit direction from the wireless terminal;
configuring a second receive spatial filter based on said trigger event;
switching, based on said trigger event, from the first receive spatial filter to the second receive spatial filter, while maintaining the first transmit spatial filter.

C12. The method of C11,
wherein the first transmit spatial filter and the first receive spatial filter are configured in a first transmission point, TRP, of the access network, and
wherein the second receive spatial filter is configured in a second TRP of the access network.

C13. The method of C11 or C12, wherein said information identifies a required transmit power reduction by the wireless terminal to transmit in the uplink for reception in the access network using the first receive spatial filter.

C14. The method of any of C11-C13, wherein said trigger event includes
receiving, from the terminal, information identifying a request to change TRP beam, and
transmitting, based on the request to change TRP beam, information identifying acceptance to transmit using a TRP beam associated with the second receive spatial filter.

C15. The method of C11 or C12, wherein obtaining information associated with the trigger event includes
determining that a link quality associated with reception using the first receive spatial filter fails to meet a link quality criterium.

C16. The method of C12, wherein obtaining information associated with the trigger event includes
transmitting, to the terminal, information identifying a request for the terminal to carry out a beam sweep;
controlling the second TRP to report data received on the second uplink channel, as identified by the terminal from said beam sweep.

C17. The method of C12 or C16, comprising
receiving, from the terminal, information identifying a request to revert back to the first TRP, and
transmitting, to the terminal, information identifying acceptance to use an uplink channel of the first TRP.

C18. The method of any of C11-C17, wherein communication with the terminal is carried out in a mm wave frequency band.

1. A method carried out in a wireless terminal for managing connection to an access network, comprising:
connecting with the access network using a first transmit spatial filter and a first receive spatial filter;
obtaining information associated with a trigger event to switch uplink transmit direction, wherein said information identifies a required transmit power reduction by the wireless terminal for using the first transmit spatial filter,
wherein the obtaining the information associated with the trigger event comprises:
transmitting, to the access network, information identifying a request to change transmission point (TRP) beam, the request identifying that the trigger event is one or more of:
a potential violation of an exposure limit; and/or
a level of required power reduction; and
receiving, based on the request to change TRP beam, information identifying acceptance to transmit with a second transmit spatial filter; and
switching, based on said trigger event, from the first transmit spatial filter to the second transmit spatial filter, while maintaining the first receive spatial filter,
wherein the first transmit spatial filter and the first receive spatial filter are configured for communication in a first direction with a first TRP of the access network,
wherein the second transmit spatial filter is configured for uplink communication with a second TRP of the access network in a second direction, which is different from the first direction.

2. The method of claim 1, wherein said information identifying a request to change TRP beam identifies beam information associated with the first transmit spatial filter.

3. The method of claim 1, wherein said information identifying a request to change TRP beam identifies beam information associated with the second transmit spatial filter.

4. The method of claim 1, wherein obtaining information comprises:
receiving, from the access network, beam information identifying the second transmit spatial filter.

5. The method of claim 1, wherein obtaining information comprises:
receiving, from the access network, information identifying a request for the wireless terminal to carry out a beam sweep; and
identifying the second transmit spatial filter based on said beam sweep.

6. The method of claim 1, further comprising:
transmitting, to the access network, information identifying a request to revert back to the first TRP, and
receiving, from the access network, information identifying acceptance to use a transmit spatial filter for uplink to the first TRP.

7. The method of claim 1, wherein communication with the access network is carried out in a millimeter wave frequency band.

8. A method, carried out in an access network for managing connection with a wireless terminal, comprising:
connecting with the wireless terminal using a first transmit spatial filter and a first receive spatial filter;
obtaining information associated with a trigger event to switch uplink transmit direction from the wireless terminal, wherein said information identifies a required transmit power reduction by the wireless terminal for using the first transmit spatial filter,
wherein the obtaining the information associated with the trigger event comprises:
receiving, from the wireless terminal, information identifying a request to change transmission point (TRP) beam, the request identifying that the trigger event is one or more of:
a potential violation of an exposure limit; and/or
a level of required power reduction;
configuring a second receive spatial filter based on said trigger event;
transmitting, based on the request to change TRP beam, information identifying acceptance to transmit using a TRP beam associated with the second receive spatial filter; and
switching, based on said trigger event, from the first receive spatial filter to the second receive spatial filter, while maintaining the first transmit spatial filter,
wherein the first transmit spatial filter and the first receive spatial filter are configured in a first transmission point, TRP, of the access network, and
wherein the second receive spatial filter is configured in a second TRP of the access network.

9. The method of claim 8, wherein said information identifies a required transmit power reduction by the wireless terminal to transmit in the switched uplink transmit direction for reception in the access network using the first receive spatial filter.

10. The method of claim 8, wherein the obtaining the information associated with the trigger event comprises:
determining that a link quality associated with reception using the first receive spatial filter fails to meet a link quality criterium.

11. The method of claim 8, wherein the obtaining the information associated with the trigger event comprises:
transmitting, to the wireless terminal, information identifying a request for the wireless terminal to carry out a beam sweep; and
controlling the second TRP to report data received on an uplink channel, as identified by the wireless terminal from said beam sweep.

12. The method of claim 8, further comprising:
receiving, from the wireless terminal, information identifying a request to revert back to the first TRP; and
transmitting, to the wireless terminal, information identifying acceptance to use an uplink channel of the first TRP.

13. The method of claim 8, wherein communication with the wireless terminal is carried out in a millimeter wave frequency band.
